(19) United States
(12) Patent Application Publication
(10) Pub. No.: US 2025/0027222 A1
(43) Pub. Date: Jan. 23, 2025

(54) APPARATUS FOR PRODUCTION OF IRON METAL BY ELECTROLYSIS

(71) Applicant: ArcelorMittal, Luxembourg (LU)

(72) Inventor: Hervé LAVELAINE DE MAUBEUGE, Metz (FR)

(21) Appl. No.: 18/714,307

(22) PCT Filed: Dec. 15, 2021
(86) PCT No.: PCT/IB2021/061736

§ 371 Date: May 29, 2024

(51) Int. Cl. C25C 1/06; C25C 7/00

(52) U.S. Cl. CPC C25C 1/06; C25C 7/00

(57) ABSTRACT

An apparatus (1) for the production of iron metal through reduction of iron ore by an electrolysis reaction, the apparatus including an electrolyte circulation device (30) including a pumping device (22) located at one extremity of the casing (4) and at least a first (31A) check valve located in the electrolyte chamber (6) and a second (31B) check valve located in the gas recovery part (8), the electrolyte circulation device (30) being designed, when actuating by an actuator (28), to aspirate the electrolyte (5) from the electrolyte chamber (6) or to pull the electrolyte (5) back into the gas recovery part (8).

The invention is related to an apparatus to produce iron metal from iron oxides by an electrolysis process.

### BACKGROUND

Steel can be currently produced at an industrial scale through two main manufacturing routes. Nowadays, the most commonly used production route consists in producing pig iron in a blast furnace, by use of a reducing agent, mainly coke, to reduce iron oxides. In this method, approx. 450 to 600 kg of coke is consumed per metric ton of pig iron; this method, both in the production of coke from coal in a coking plant and in the production of the pig iron, releases significant quantities of CO₂.

The second main route involves so-called “direct reduction methods”. Among them are methods according to the brands MIDREX, FINMET, ENERGIRON/HYL, COREX, FINEX etc., in which sponge iron is produced in the form of HDRI (Hot Direct Reduced Iron), CDRI (cold direct reduced iron), or HBI (hot briquetted iron) from the direct reduction of iron oxide carriers. Sponge iron in the form of HDRI, CDRI, and HBI usually undergo further processing in electric arc furnaces. Even if this second route emits less CO2 than the previous one it still releases some and rely moreover on carbon fossil fuels.

Current developments thus focus on methods allowing to produce iron which release less or even no CO₂ and which is carbon-neutral.

A known alternative method to produce steel from iron ores made of iron oxides is based on electrochemical techniques. In such techniques, iron is produced from iron oxide using an electrolyser unit comprising two electrodes—an anode and a cathode—connected to a source of electric current, an electrolyte circuit and an iron oxide entry into the electrolyser unit. The anode and cathode are constantly immersed in the circulating electrolyte in order to ensure good electrical conduction between said electrodes. The electrolytic reaction produces pure iron plates on the cathode and gaseous oxygen at the anode. Iron plates thus obtained may then be melted with other elements such as a carbon source and scrap in electric furnaces to produce steel.

### SUMMARY OF THE INVENTION

In order to limit the environmental footprint of the process, electrolyte is recirculated within the cell to limit the need of fresh electrolyte. In order to do so external pumps are currently used between electrolyte inlet and outlet of the electrolyse cell. These pumps consume energy and induce heat losses which makes the process very energy consuming and with high operative cost which makes it upscaling at a high production rate difficult.

An aim of the present invention is therefore to remedy the drawbacks of the prior art by providing a system for electrochemical iron production with an improved energy efficiency.

The present invention provides an apparatus for the production of iron metal through reduction of iron ore by an electrolysis reaction, this apparatus comprising a casing including a gas permeable anode plate, a cathode plate, both facing each other and being separated by an electrolyte chamber, the casing being provided with means for supplying an electrolyte within the chamber and with means to supply iron ore to said chamber, the casing further including a degassing unit comprising a gas recovery part extending along the opposite side of the anode plate to the chamber and an electrolyte recirculation part extending continuously from the gas recovery part up to a gas outlet and being in fluidic connection with the chamber, the apparatus further comprising a electrolyte circulation device including a pumping device located at one extremity of the casing and at least a first non-return device located in the electrolyte chamber and a second non-return device located in the gas recovery part, said electrolyte circulation device being designed, when actuating by an actuator, to aspirate the electrolyte from the electrolyte chamber or to pull the electrolyte back into the gas recovery part.

The apparatus may also include the following optional characteristics considered individually or according to all possible combination of techniques:
the pumping device is located in the extremity of the casing opposite to the means for supplying the electrolyte, the pumping device is located outside of, but in fluidic connection with, the casing,
the pumping device is located partly inside the casing,
the non-return devices are elastic membranes made of electrically insulating material,
the elastic membranes are made of Ethylene propylene diene monomer,
the non-return devices are mechanical valves made of electrically insulating material,
the actuator of is an hydraulic actuator,
the apparatus is powered by renewable energy.

### BRIEF DESCRIPTION OF THE DRAWINGS

Other characteristics and advantages of the invention will be apparent in the below description, by way of indication and in no way limiting, and referring to the appended figures among which:

FIG. 1A, which represents a longitudinal section view of an apparatus according to the invention wherein the electrolyte circulation device is in aspiration mode, and

FIG. 1B, which represents a longitudinal section view of an apparatus according to the invention wherein the electrolyte circulation device is in pull-back mode.

### DETAILED DESCRIPTION

First, it is noted that on the figures, the same references designate the same elements regardless of the figure on which they feature and regardless of the shape of these elements. Similarly, should elements not be specifically referenced in one of the figures, their references may be easily found by referring to another figure.

It is also noted that the figures represent mainly one embodiment of the object of the invention but other embodiments which correspond to the definition of the invention may exist. Elements in the figures are illustration and may not have been drawn to scale.

The invention refers to an apparatus 1 provided for the production of iron metal (Fe) through the reduction of iron ore, containing notably hematite (Fe₂O₃) and other iron oxides or hydroxides, by an electrolysis reaction. Said chemical reaction is well known and may be described by the following equation (1):

$${Fe}_{2} {O}_{3} ↔ 2 Fe + \frac{3}{2} {O}_{2} \qquad ( 1 )$$

The electrolysis reaction thus generates gases—mainly oxygen—that have to be extracted from the apparatus 1.

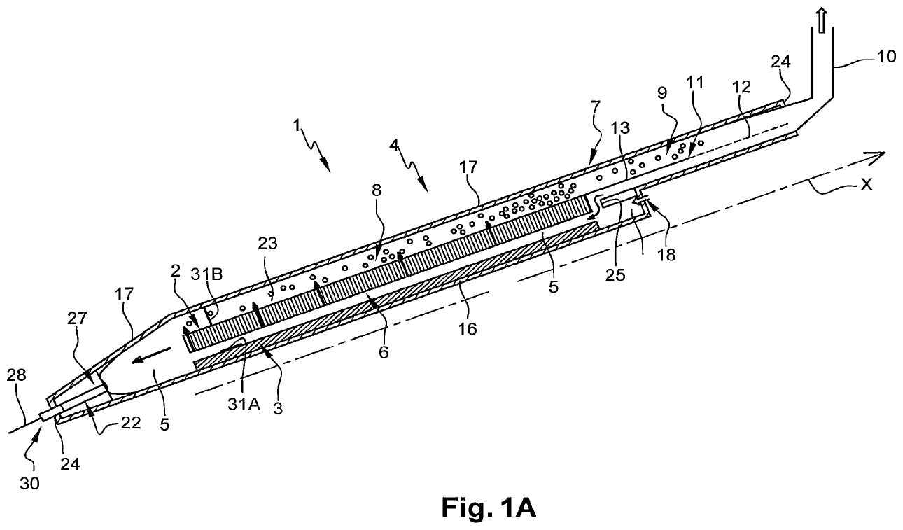

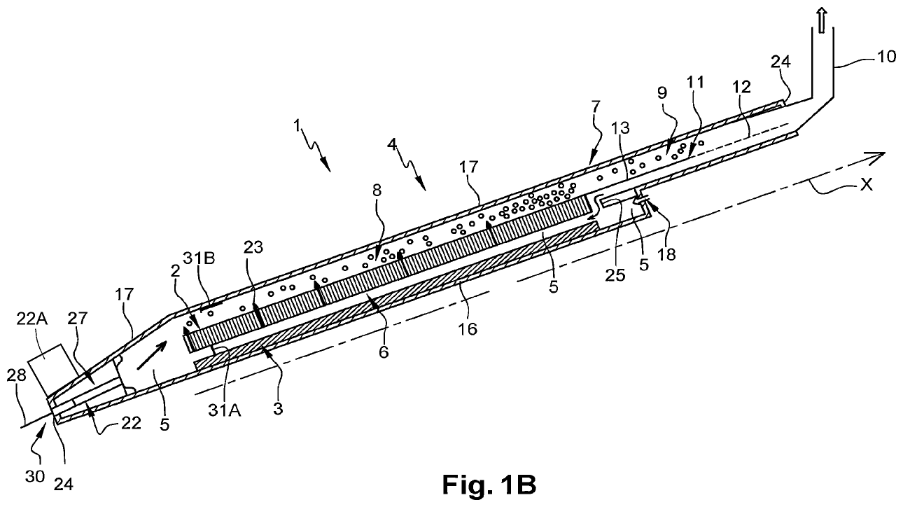

With reference to FIGS. 1A and 1B, the apparatus 1, or electrolyse cell, comprises a casing 4 extending along a longitudinal axis X in which the electrolysis reaction occurs. Said casing 4 is delimited by a base plate 16, a cover plate 17 and two lateral plates 24. In addition, the casing includes a gas permeable anode plate 2 intended to be totally immersed in an electrolyte 5 and a cathode plate 3, both plates facing each other, and being kept at the required distance with fastening means. The casing 4 also includes an electrolyte chamber 6 extending longitudinally between the anode plate 2 and the cathode plate 3 up to an evacuation chamber 27. The apparatus 1 finally comprises an electrical power source connected to the anode plate 2 and the cathode plate 3.

In order to produce iron metal through the electrolysis reaction, the electrolyte 5—preferably a water-based solution, like a sodium hydroxide aqueous solution—flows through the casing 4 inside the electrolyte chamber 6 while the apparatus 1 is operating. The apparatus 1 thus comprises an inlet 18 managed in the casing 4 fluidically connected to the electrolyte chamber 6. Iron ore is preferentially supplied into the apparatus 1 as a powder suspension within the electrolyte 5 through the inlet 18.

During the electrolysis reaction, oxidised iron is reduced to iron metal according to reaction (1) and reduced iron is deposited on the cathode plate 3 while gaseous oxygen is generated. As depicted above, gases are generated inside the casing 4. Since these gases are electrical insulator, they prevent the good working of the electrolysis reaction and are thus continuously evacuated outside of the casing 4.

For this purpose, the casing 4 includes a degassing unit 7 comprising a gas recovery part 8 extending longitudinally along the opposite side 23 of the anode plate 2 to the electrolyte chamber 6. This gas recovery part 8 is a compartment provided to be filled with the electrolyte 5 and disposed between the anode plate 2 and the cover plate 17. Said gas recovery part 8 is thus provided to recover gases (dioxygen and dihydrogen) escaping through the anode plate 2.

As depicted in FIGS. 1A and 1B, the degassing unit 7 also comprises an electrolyte recirculation part 9 extending in continuity with the gas recovery part 8 up to a gas outlet 10 managed in the casing 4. The electrolyte recirculation part 9 is provided to be at least partly filled with the electrolyte 5. In addition, said recirculation part 9 is in fluidic connection with the electrolyte chamber 6. When the apparatus 1 is operating, the recirculation part 9 allows the electrolyte 5 flowing from the gas recovery part 8 to be redirected towards the electrolyte chamber 6 preferentially via an elbow duct 25 of the electrolyte recirculation part 9 which is adjacent to the anode plate 2 and fluidically connected to the electrolyte chamber 6. This electrolyte recirculation part 9 preferentially comprises a gas-liquid partition means allowing to improve separation between the gases to be evacuated through the gas outlet 10 and the electrolyte to be recirculated within the electrolyte chamber 6. This gas-liquid partition means may be for example a solid plate extending along the recirculation part 9 comprising perforations for the gas-liquid separation.

In the apparatus 1 according to the invention, the casing 4 further comprises an electrolyte recirculation device 30 including a pumping device 22 located at one of its extremity and at least two check valves 31A, 31B. Location at the extremity allows to take benefit of the full-width of the apparatus for pumping and thus increase the efficiency of the recirculation. It can be located externally (represented solely schematically in FIG. 1B as alternative pump 22A) of the casing 4 or at least partly internally, as depicted in FIGS. 1A and 1B. It is preferentially located at the bottom 27 of the cell, opposite to the electrolyte inlet 21. This pumping device 22 maybe a pneumatic membrane pump. It is activated by an actuator 24, said actuator maybe a pneumatic cylinder or a hydraulic actuator.

The person skilled in the art knows how to size the pumping device and which flow rate and frequency of pumping are needed according to the size of the electrolysis cell to insure a good recirculation of the electrolyte.

The pumping device 22 is associated to at least two check valves 31A, 31B, the first one 31A being located in the electrolyte chamber 6 and the second one 31B being located in the gas recovery part 8. These non-return flow-devices 31A, 31B maybe elastic membranes or mechanical valves. They are made of electrically insulating materials. When they are membranes, they may be made of Ethylene propylene diene monomer (EPDM). They may also be a combination of those different types of devices.

The working of the apparatus 1 during the electrolysis reaction will now be described.

The electrolyte 5 is continuously circulating inside a circuit, through the electrolyte chamber 6 from the inlet 18 towards the evacuation chamber 27 thanks to the pumping device 22 and the check valves 31A, 31B. The electrical power source connected both to the anode plate 2 and to the cathode plate 3 is turned on and the electrolyte chamber 6 is regularly fed with iron ore coming from the means 21 to supply iron ore to the apparatus 1. The casing 4 is almost filled with electrolyte 5, as depicted in FIGS. 1A and 1B, and only the gas outlet 10 is free of electrolyte. In these conditions the electrolysis reaction may occur.

Iron ore is reduced, and pure iron is deposited on the cathode surface 3, while generated oxygen flow, together with the electrolyte, through the anode plate 2 towards the gas recovery part 8 of the degassing unit 7.

To allow gases circulation from the gas recovery part 8 towards the electrolyte recirculation part 9 and finally to the gas outlet 10, the longitudinal axis X is preferentially inclined relative to a horizontal direction following an angle comprised between 40° and 60°, preferentially 50°. The gas outlet 10 is thus in the highest position of the casing 4 to allow gases evacuation.

While circulating through the gas recovery part 8, the moving gases drive electrolyte 5 from said recovery part 8 to the recirculation part 9. The gases are continuously flowing toward the gas outlet 10, while the electrolyte 5 is driven by gravity to the electrolyte chamber 6 and recirculates in the circuit 20. This circulation with the gases is however not sufficient to insure a good recirculation of the electrolyte 5. The pumping device is thus continuously aspirate and pull back the electrolyte within the apparatus.

In aspiration mode as illustrated in FIG. 1A the first check valve 31A located in the electrolyte chamber 6 is opened while the second check valve 31B located in the gas recovery part 8 is closed. The pumping device 22 is activated by the actuator 28 to aspirate the electrolyte 5 from the electrolyte chamber 6.

In pull-back mode as illustrated in FIG. 1B the first check valve 31A located in the electrolyte chamber 6 is closed while the second check valve 31B located in the gas recovery part 8 is open. The pumping device 22 is activated by the actuator 28 to pull the electrolyte 5 back to the gas recovery part 8. In a preferred embodiment when the pumping device 22 is located in the bottom part of the cell the pulled-back flow superposes additively with the flow generated by the buoyancy of the gas escaping through the anode 2.

It is then possible to recirculate the electrolyte 5 within the electrolyte chamber 6 without inducing gas accumulation at the cathode level. This prevents the need to regularly inject a fresh electrolyte flow within the apparatus 1.

In all the previously described embodiments the apparatus is preferentially powered by renewable energy which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO2 to be produced. This further limits the CO2 footprint of the iron production process.

What is claimed is:

1-9. (canceled)

10. An apparatus for the production of iron metal through reduction of iron ore by an electrolysis reaction, the electrolysis reaction generating a gas, the apparatus comprising:
a casing including a gas permeable anode plate and a cathode plate facing each other and being separated by an electrolyte chamber, the casing having a supply for supplying an electrolyte within the chamber and an iron ore supply to supply iron ore to the chamber, the casing further including a degassing unit including a gas recovery part extending along the opposite side of the anode plate to the chamber and an electrolyte recirculation part extending continuously from the gas recovery part up to a gas outlet and being in fluidic connection with the chamber, and
a electrolyte circulation device including a pump located at one extremity of the casing and at least a first check valve located in the electrolyte chamber and a second check valve located in the gas recovery part, the electrolyte circulation device being designed, when actuated by an actuator, to aspirate the electrolyte from the electrolyte chamber or to pull the electrolyte back into the gas recovery part.

11. The apparatus as recited in claim 10 wherein the pump is located in the extremity of the casing opposite to the supply for supplying the electrolyte.

12. The apparatus as recited in claim 10 wherein the pump is located outside of, but in fluidic connection with, the casing.

13. The apparatus as recited in claim 10 wherein the pump is located partly inside the casing.

14. The apparatus as recited in claim 10 wherein the check valves are elastic membranes made of electrically insulating material.

15. The apparatus as recited in claim 14 wherein elastic membranes are made of ethylene propylene diene monomer.

16. The apparatus as recited in claim 10 wherein the check valves are mechanical valves made of electrically insulating material.

17. The apparatus as recited in claim 10 wherein the actuator is a hydraulic actuator.

18. The apparatus as recited in claim 10 wherein the apparatus is powered by renewable energy.
